(19) United States
(12) Patent Application Publication
(10) Pub. No.: US 2008/0307227 A1
(43) Pub. Date: Dec. 11, 2008

(54) Digital-Invisible-Ink Data Hiding Schemes

(75) Inventors: Chun-Hsiang Huang, Taipei City (TW); Ja-Ling Wu, Taipei City (TW)

Correspondence Address: WPAT, PC, 7225 BEVERLY ST., ANNANDALE, VA, 22003, US

(73) Assignee: NATIONAL TAIWAN UNIVERSITY, Taipei City (TW)

(21) Appl. No.: 11/758,725

(22) Filed: Jun. 6, 2007

(51) Int. Cl. H04L 9/00

(52) U.S. Cl. 713/176

(57) ABSTRACT

A novel steganographic approach analogous to the real-world secret communication mechanism, in which messages to be concealed are written on white papers using invisible ink like lemon juice or milk and are revealed only after the papers are heated, is proposed. Carefully designed informed-embedders now play the role of “invisible ink”; some pre-negotiated attacks that can be provided by common content processing tools correspond to required “heating” process. Theoretic models and feasible implementations of the proposed digital-invisible-ink (DII) watermarking approach are provided. The proposed DII watermarking schemes can prevent the supervisor from interpreting secret messages even the watermark extractor, decryption tool, as well as session keys are available to the supervisor. Furthermore, under certain steganographic application scenarios, secret communication systems employing the DII watermarking schemes can aggressively mislead the channel supervisor with fake payloads and transmit genuine secrets at the same time.

### BACKGROUND OF THE INVENTION

1. Field of the Invention

The present invention generally relates to a data hiding scheme, and more particularly to a digital-invisible-ink (DII) data hiding mechanism.

2. Description of the Prior Art

In ancient times, secret messages are written on parchments using special inks and are only visible when the parchments are heated under fire. A watermark technique embeds a symbol, a mark or a trademark that represents the ownership of the inventor into data. When the ownership is in controversy, one can prove his ownership based on the watermark. In military use, images and texts are used to transmit secret information.

With the arrival of the information era, many digital images, audios and videos require appended information to protect their ownership. As a result, digital watermarks are created. Secret information that can be embedded into digital content may be images or text strings that have specific meanings.

In the prior art, commonly seen watermarking mechanisms include spread-spectrum watermarking and quantization watermarking. The so-called spread-spectrum technique spreads the originally narrowband signals into signals over a larger (few multiples of the original) bandwidth. Such spreading lowers the energy of the original signals, sometimes even to a level lower than the background noise. Spread-spectrum watermarking exploits this feature by treating the digital content as a wideband signal and the watermark a narrowband signal, and spreading the watermark narrowband signal into a wideband signal, which is then embedded it into the digital content, as can be seen in “Secure Spread Spectrum Watermarking for Multimedia” by Cox, I. et al., IEEE Transactions on Image Processing, vol. 6, no. 12, December 1997. More specifically, the spread-spectrum watermarking mechanism is as follows. A watermark W is converted into a sequence W=w₁, w₂ . . . , wₙ with a random length 105 (referring to FIG. 1B) based on Gaussian distribution (referring to FIG. 1A). FIG. 1C illustrates discrete cosine transform (DCT) formulae, which include a Forward DCT (FDCT) formula 110 and an Inverse DCT (IDCT) formula 115. An original digital image X is transformed into an image X′ with a DC component 120, a lower frequency band component 125, a middle frequency band component 130 and a higher frequency band component 135 (referring to FIG. 1D) according to the FDCT formula, wherein the DC component 120 is the strongest region. FIG. 1E depicts changes to the original digital image data array 140 when undergoing the FDCT 145 and IDCT 150. Thereafter, n strongest signals (y₁ . . . , yₙ) are selected from X′ and signal values y′ required for each embedded watermark is computed according to the formula y′=yᵢ+αwᵢ. Then, y′ is used to replace the contents of X′, wherein α is a weighting factor. Extracting the watermark includes obtaining W* by computing each wᵢ=(yᵢ*−yᵢ)/α, and computing the likelihood between W* and W.

As shown in FIG. 2, the quantization watermarking scheme involves determining whether, in an original document C₀, each of the locations into which watermarks are to be inserted is greater than a threshold value T, based on the determination, each watermark bit b to be embedded is encoded as 1 or −1, respectively corresponding to a white pixel 200 or a black pixel 210 in the watermark pattern. The watermark is a binary pattern having a specific meaning. More detailed discussions about quantization watermarking can be found in “Quantization Index Modulation: A Class of Provably Good Methods for Digital Watermarking and Information Embedding” by Chen B. et al., IEEE Transactions on Information Theory, vol. 47, pp 1423-1443, May 2001. Thus, details of which will not be further described.

In the field of steganography, it is common to use the watermarking and key encryption/decryption mechanisms to hide secret information. However, the prior is prone to extraction failure of the secret information while the latter has security concern especially in the process of transmitting a key.

### SUMMARY OF THE INVENTION

In view of the prior art and the needs in the related industries, the present invention provides a digital-invisible-ink (DII) information hiding scheme that solves the abovementioned shortcomings of the conventional information hiding techniques.

One objective of the present invention is to provide a DII information hiding scheme. A transmitter embeds secret messages into digital content using traditional digital information hiding technique(s), and performs an attack on the digital content embedded with the secret message. One common attack is a multimedia processing operation (e.g. compression or quality enhancement etc.). Then, an information extraction process is performed on the tampered digital content so as to extract a secret message. The extracted secret message is compared with the original secret message. If they do not match, then the secret message is re-embedded into the digital content at an incremented strength. The above processes are looped until the extracted secret message matches with the original. A recipient is required to perform the pre-negotiated attack on the received digital content embedded with the secret message in order to extract the correct secret message. The present invention proposes a method for hiding secret information in a digital content, including: providing a digital content and at least one secret information, providing a weight series including a plurality of different weighting factors, performing a method for embedding each secret information, and outputting the digital content.

The method for embedding each secret information includes generating secret information corresponding to the various weighting factors according to the secret information and the weighting factors, embedding each secret information with different weighting factor into the digital content to generate respective digital content embedded with secret information corresponding to the various weighting factors, performing a predefined attack on each of the digital content embedded with secret information corresponding to the various weight factors to generate respective tampered digital content corresponding to various weighting factors, extracting tampered secret information corresponding to various weighting factors from the tampered digital content corresponding to various weighting factors, respectively, matching each of the tampered secret information corresponding to various weighting factors with the secret information so as to identify whether each of the weighting factors is a matching weighting factor or a mismatching weighting factor, identifying a smallest matching weighting factor from all the matching weighting factors, and embedding the secret information corresponding to the smallest matching weighting factor into the digital content.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1A is a Gaussian distribution diagram;

FIG. 1B is diagram showing a sequence with a random length that fits the Gaussian distribution;

FIG. 1C illustrates discrete cosine transform (DCT) formulae;

FIG. 1D is a baseband image frequency diagram after FDCT;

FIG. 1E is a schematic diagram depicting changes to the original digital image data array when undergoing the FDCT and IDCT transformations.

FIG. 2 is a schematic diagram showing a simple single-bit quantization watermarking scheme;

FIG. 3A is a schematic diagram illustrating an embodiment of the DII information hiding scheme;

FIG. 3B is a schematic diagram illustrating another embodiment of the DII information hiding scheme;

FIG. 4A is a schematic diagram illustrating a DII spread-spectrum watermarking scheme;

FIG. 4B is a geometric model diagram of watermark extraction that fits the DII spread-spectrum watermarking scheme;

FIG. 4C is a geometric model diagram of watermark extraction that does not fit the DII spread-spectrum watermarking scheme;

FIG. 5A is a schematic diagram illustrating a flowchart of a quantization-watermarking-based DII information embedding scheme.

FIG. 5B is a schematic diagram illustrating the effect of disguise achieved by the quantization watermarking scheme.

FIG. 5C is a schematic diagram depicting deceptive information used to hide the genuine information;

FIG. 6 is a block diagram showing the system for hiding and extracting secret information to/from digital content according to an embodiment of the present invention, wherein a watermark is embedded into the digital content;

FIG. 7 is a block diagram showing the system for hiding and extracting secret information to/from digital content according to another embodiment of the present invention, wherein a watermark is used to embed a plurality of secret information into the digital content; and

FIG. 8 is a block diagram showing the system for hiding and extracting secret information to/from digital content according to yet another embodiment of the present invention, wherein a spectrum spreading module generates a plurality of secret information.

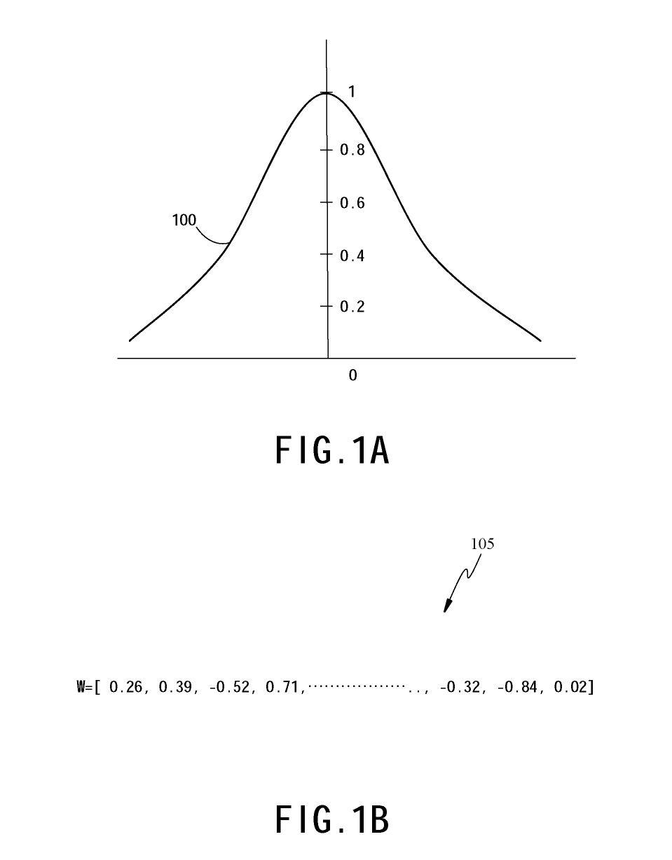

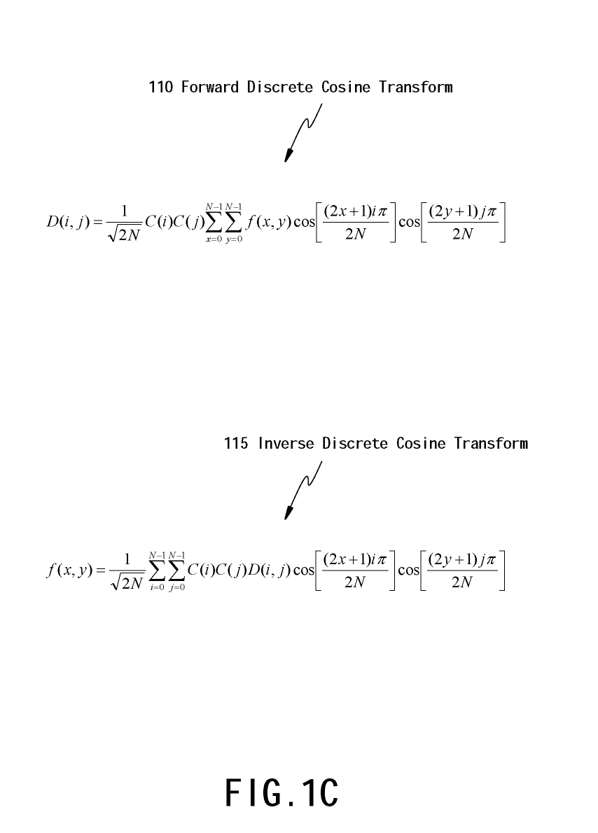

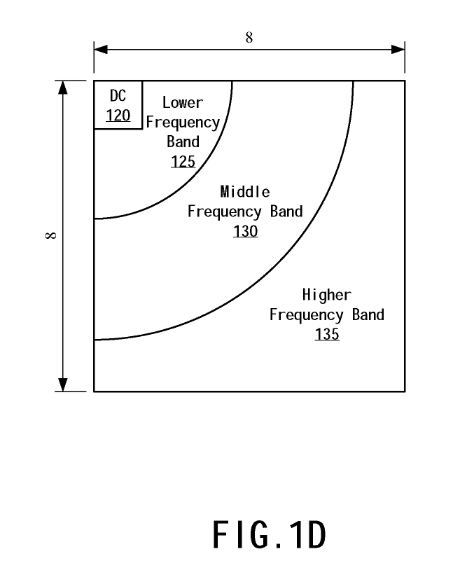

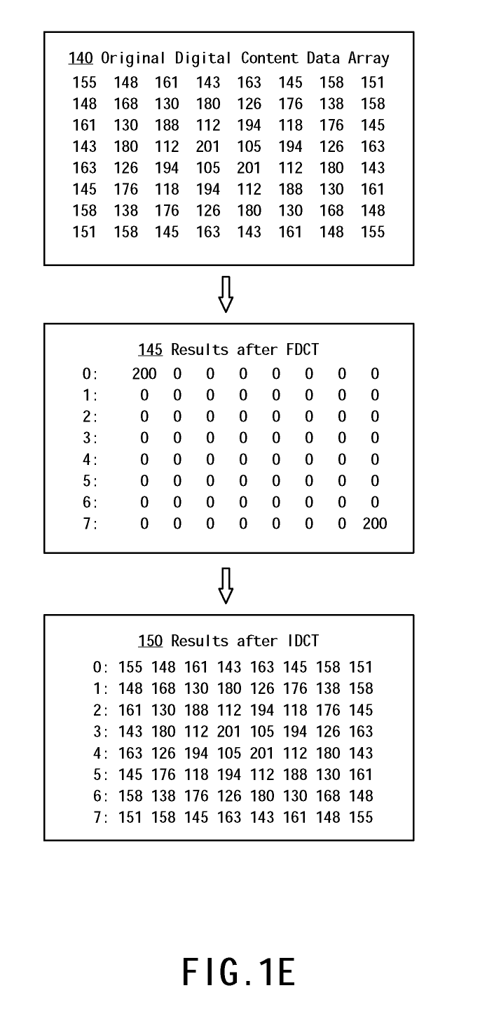

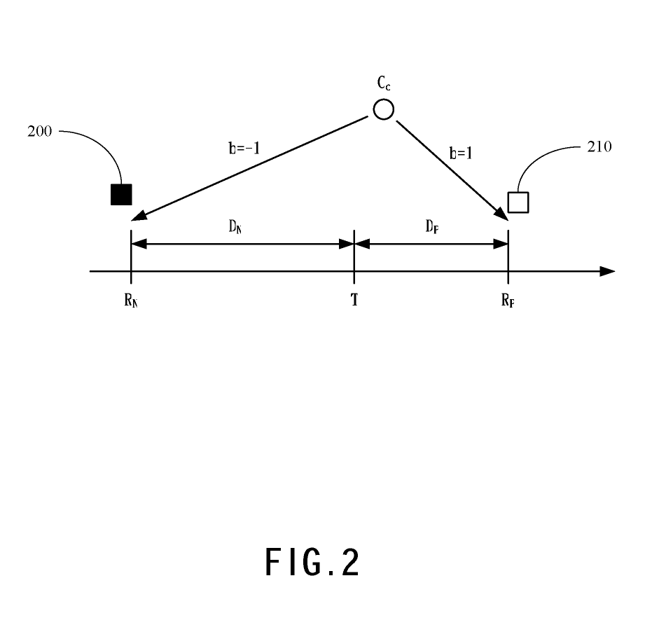

### DETAILED DESCRIPTION OF THE PREFERRED EMBODIMENTS

The present invention is directed to a digital-invisible-ink (DII) information hiding scheme. Detailed steps and constituents are given below to assist in the understanding the present invention. Obviously, the implementations of the present invention are not limited to the specific details known by those skilled in the art of digital information hiding schemes. On the other hand, well-known steps or constituents of digital watermarking are not described in details in order not to unnecessarily limit the present invention. Detailed embodiments of the present invention will be provided as follow. However, apart from these detailed descriptions, the present invention may be generally applied to other embodiments, and the scope of the present invention is thus limited only by the appended claims.

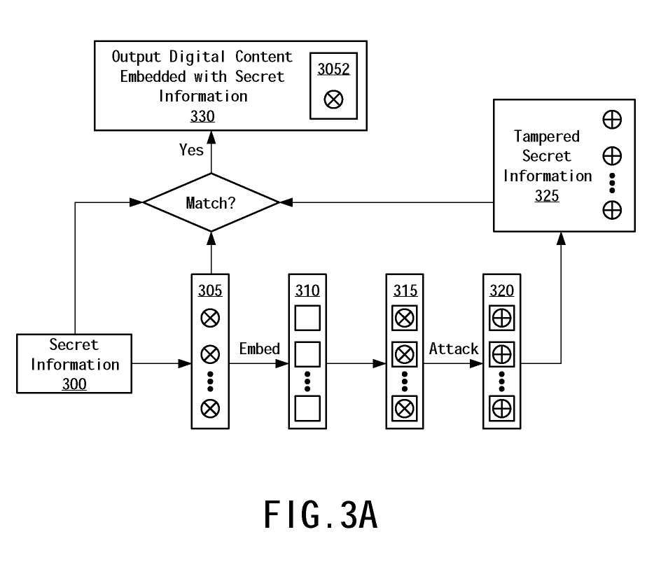

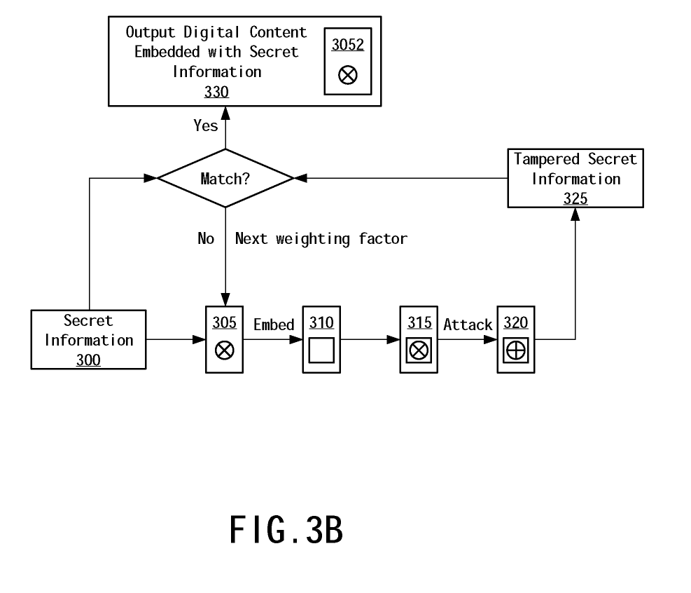

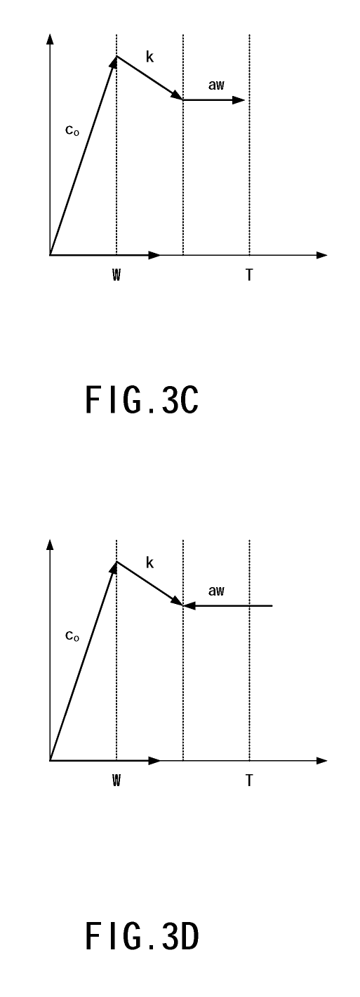

Referring to FIG. 3A, a flowchart showing a DII information hiding scheme is provided. The present invention discloses a method for hiding information within digital content that allows one or more secret information 300 to be hidden in the digital content 310. The method of the present invention provides a weight series that includes a plurality of different weighting factors. The embedding method is performed on the one or more secret information 300 sequentially. The method for embedding secret information includes the following steps.

First, secret information 305 corresponding to various different weighting factors are generated using the secret information 300 and the weight series.

Then, each secret information 305 that corresponds to a particular weighting factor is embedded into digital content 310 to generate respective digital content 315 with the embedded secret information that corresponds to a particular weighting factor, wherein the secret information corresponding to different weighting factors are arranged in order, for example, from the smallest to the largest or vice versa.

A predefined attack is performed on each digital content 315 with embedded secret information that corresponds to a particular weighting factor, so as to generate respective tampered digital content 320 corresponding to the particular weighting factor. Thereafter, tampered secret information 325 corresponding to various different weighting factors are respectively extracted from the tampered digital content 320 corresponding to various different weighting factors. Then, each of the tampered secret information 325 corresponding to a particular weighting factor is matched with the original secret information 300 to determine whether each of the weighting factor is a matching weighting factor or a mismatching weighting factor. That is, a weighting factor is a matching weighting factor when the tampered secret information 325 corresponding to the weighting factor matches the original secret information 300, and vice versa. From the matching weighting factors, the smallest matching weighting factor is identified, and the secret information corresponding to the smallest matching weighting factor 3052 is embedded into the digital content 310. The above-described weight series includes a sequentially adjacent first weighting factor and a second weighting factor. The secret information corresponding to the second weighting factor may be generated after the tampered secret information of the first weighting factor is matched with the secret information. The embedding of the secret information corresponding to the smallest matched weighting factor 3052 into the digital content 310 may comprise replacing the digital content 310 by the digital content 315 having the embedded secret information corresponding to the smallest matched weighting factor 3052.

Alternatively, the secret information corresponding to the smallest matched weighting factor 3052 may be embedded into the digital content 310 after the smallest weighting factors for all the secret information 3052 are identified. Moreover, when the weight series is arranged in order from small to large, and wherein when the first weighting factor is the largest mismatching weighting factor and the second weighed value is the smallest matching weighting factor, the digital content 315 with embedded secret information that corresponds to the largest mismatching weighting factor replaces the original digital content 310 at the time the second weighting factor is identified as the smallest matching weighting factor.

When the weight series is arranged from large to small, and wherein when the first weighting factor is the smallest matching weighting factor and the second weighed value is the largest mismatching weighting factor, the digital content 315 with embedded secret information that corresponds to the largest mismatching weighting factor replaces the digital content 310 when the second weighting factor is identified as the largest mismatching weighting factor.

Alternatively, the secret information corresponding to the largest mismatching weighting factor may be embedded into the digital content 310 after the largest mismatching weighting factors for all the secret information are identified. The above matching of the tampered secret information corresponding to various different weighting factors with the original secret information generates likelihood values that correspond to different weighting factors. When the likelihood value is greater than a threshold value, the weighting factor corresponding to that likelihood value is identified as a matching weighting factor; otherwise, it is identified as a mismatching weighting factor.

Finally, after each secret information is embedded, the final digital content 330 is outputted. The above secret information 300 may include a plurality of values; each value is embedded into a different predefined location in the digital content 310, such that the tampered secret information 325 corresponding to each weighting factor is extracted from the plurality of predefined locations in the tampered digital content 320 corresponding to the specific weighting factor. The above weighed values can be generated one at a time for the embedding process for each of the secret information is carried out, as shown in FIG. 3B.

Additionally, the method for hiding information in digital content further includes providing a secret digital content and a plurality sets of number series that are pseudo-randomly arranged, selecting a set of pseudo-random number series as a predefined pseudo-random number series and generating at least one secret information from the secret digital content and the predefined pseudo-random number series. The matching of each of the tampered secret information corresponding to a different weighting factor with the secret information includes two methods. The first method matches each of the tampered secret information corresponding to a different weighting factor with the plurality sets of pseudo-random number series to find respective the most matching pseudo-random number series corresponding to the different weighting factors, and identifies the weighting factor having the most matched pseudo-random number series being the predefined pseudo-random number series as the matching weighting factor; otherwise as the mismatching weighting factor. The second method matches each of the tampered secret information corresponding to a different weighting factor with the plurality sets of pseudo-random number series to find respective the most matching pseudo-random number series corresponding to the different weighting factors, reconstructs respective reconstructed information based on each of the most matching pseudo-random number series corresponding to various different weighting factors and the tampered secret information, and identifies the weighting factor with corresponding reconstructed information matching the secret information as the matching weighting factor; otherwise as the mismatching weighting factor. The above secret digital content comprises a plurality of binary bits; each binary bit is designated as one of 1 or −1 according to its binary value and multiplied with the predefined pseudo-random number series to generate a respective secret information.

In summary of the above, the DII information hiding scheme of the present invention has the following features: receiver must perform certain multimedia process (attack) to the received digital multimedia data, in order to accurately or unambiguously obtain the genuine information. How the secret information is embedded will depend on the effect the specific digital process had on the information hiding scheme.

The embedding process of the true secret information can be performed in an iterative manner by gradually incrementing the information strength starting from the lowest information strength (referring to the geometric model in FIG. 3C). Each time secret information is embedded into the digital content C₀, a predefined digital process (attack) k is performed on the generated digital content and accurate extraction of genuine information is checked. Once that information can be accurately extracted (i.e. C₀ k aw reaches a threshold T) after the digital process k has been performed on the digital multimedia, stop incrementing the information strength aw of that information. Alternatively, signal is iteratively embedded starting from the strongest information strength (referring to the geometric model in FIG. 3D). Each time a secret information is embedded into the digital content C₀, a predefined digital process (attack) k is performed on the generated digital content and accurate extraction of genuine information is checked. Once that information cannot be accurately extracted (i.e. C₀ k aw reaches the threshold T) after the digital process k has been performed on the digital multimedia, stop decrementing the information strength aw of that information. Accordingly, a threshold T only above which the secret information can be correctly extracted is successfully established with certain operating timeframe.

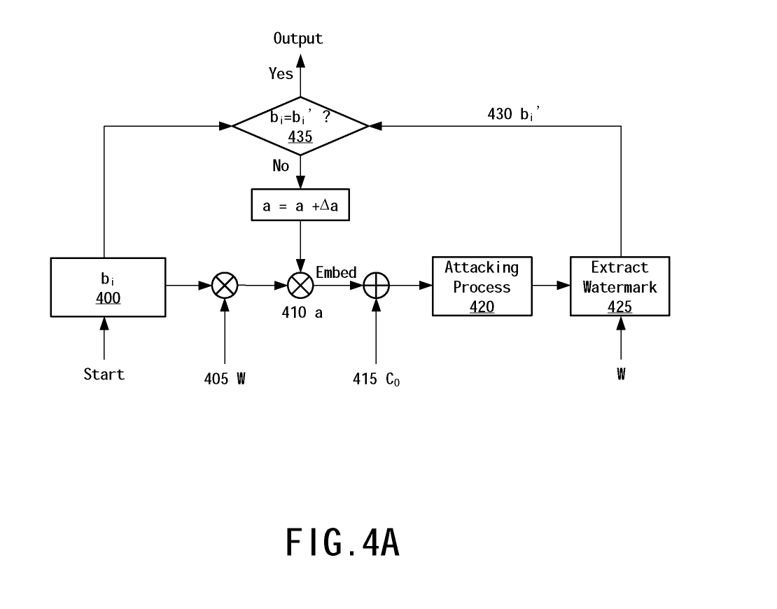

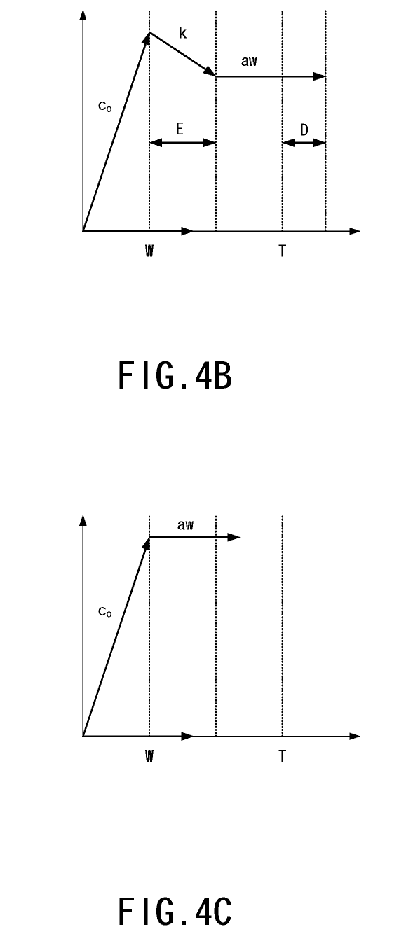

As such, the current spread-spectrum watermarking scheme can be modified by the present invention for implementation. FIG. 4A is a schematic diagram depicting a flowchart of a spread-spectrum watermarking based DII information embedding scheme. In FIG. 4A, bᵢ is a secret information bit to be added (as shown by step 400), bᵢ′ is the secret information bit extracted after an iterative process. C₀ is the original digital content, w is the random sequence representing bᵢ in the spread-spectrum watermarking scheme (as shown by step 405), a is the weighting factor of the strength of the random sequence when embedding w (as shown by step 410), Δa is the incrementing unit for each iteration, which is usually set to a small value (e.g. 0.1). The embedding process is completed when every bit in the secret information can be successfully embedded into the digital content under the influence of a specific digital process. The above iterative processes include performing a specific digital process on the digital content with embedded secret information to generate a tampered digital content, as shown by step 420. When a secret information bit bᵢ′ is extracted from the tampered digital content by a watermark extracting module, as shown by step 425, the extracted secret information bit bᵢ′ is matched with the original secret information bit bᵢ. If the result is a mismatch, then the process is iterated. If the result is a match, then the digital content with the embedded secret information is outputted.

FIGS. 4B and 4C are geometric model plots illustrating the effects of the digital invisible ink, wherein vector k indicates the specific digital process (attack). When the sum of all vectors exceeds T, detection is successful. T indicates the threshold value for detecting the secret signal. E is the value of influence the specific process on the detection. D is the extent of detection beyond T after embedding using the scheme shown in FIG. 4A. Referring to FIG. 4B, the influence the specific process had on the detection is positive (assist in detection) and E>D. The embedded bits can be accurately detected if the specific process is performed before detection. Referring to FIG. 4C, if no such process is performed before detection (i.e. the influence of k disappears), detection will fail.

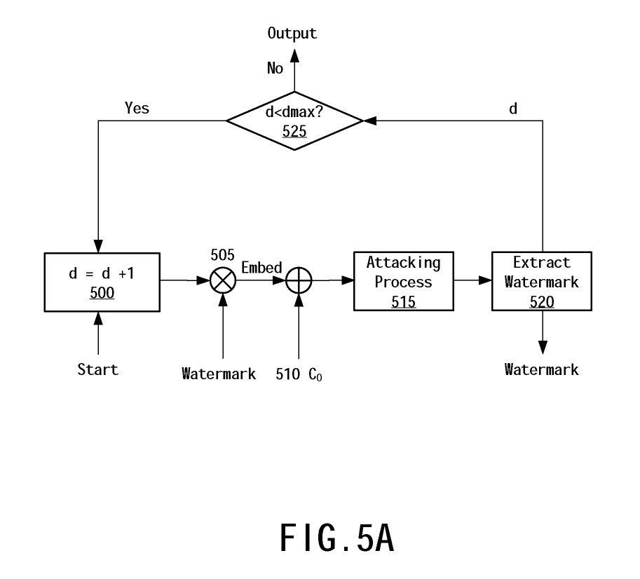

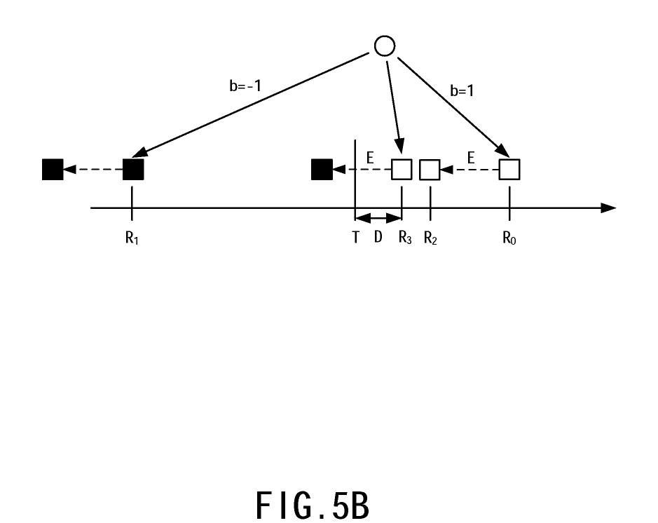

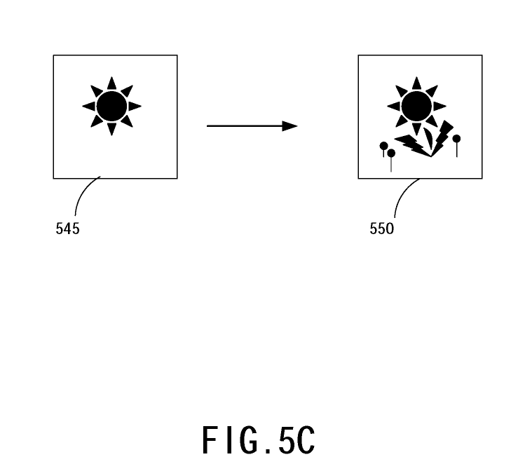

The current quantization watermarking scheme can be modified by the present invention for implementation. FIG. 5A is a schematic diagram illustrating a flowchart of a quantization-watermarking-based DII information embedding scheme. d is the incrementing quantization watermark strength and dₘₐₓ is the largest testing strength. A process of embedding quantization watermark is iteratively performed. In step 500, the initial watermark strength is d=1. The watermark strength d increments by one each time step 500 is executed. In steps 505 and 510, the watermark is embedded into the original document C₀ based on the strength d using the quantization watermarking scheme. Next, a specified attacking process is carried out on the digital document embedded with the watermark in step 515. The watermark is then extracted from the tampered digital content in step 525. Then, it is determined whether the strength of the extracted watermark d exceeds the largest testing strength dₘₐₓ. If not, then the steps 500 to 525 are continued until the strength of the extracted watermark d exceeds the largest testing strength dₘₐₓ.

Additionally, the present invention further includes determining whether the extracted watermark matches with the original watermark. Thus, each extracted watermark that was embedded into the original document C0 at different strength d can be considered as corresponding to that strength d after being processed by the specified attack. Among all the extracted watermarks after matching with the original watermark, the largest corresponding strength d is the desired strength d. Thereby, the digital content embedded with the watermark at the desired strength d is outputted.

Accordingly, it is obvious to one skilled in the art that the watermark strength can be considered as the abovementioned weighting factor. Also, the determining in step 525 may be modified as to determine whether the watermark strength d is the largest corresponding strength d among all the extracted watermarks that match with the original watermark 505, or determine whether the extracted watermarks match with the original watermark. Moreover, it is easily conceivable that the watermark is embedded into the original digital document C₀ at strength d using the quantization watermarking method by embedding with opposite values.

Additionally, the quantization watermarking scheme can be used to disguise genuine information. Referring to FIG. 5B, which is a schematic diagram illustrating the effect of disguise achieved by the quantization watermarking scheme. Basically, the definitions of D, E and T are the same as in the second embodiment, but the watermarks used here is a binary pattern with specific meanings. During detection of a watermark, if the computed value is smaller than T, e.g. R₁, then it means a corresponding black pixel in the watermarking pattern is embedded; if the computed value is greater than T, then it indicates a white pixel, e.g. R₀. Referring to FIG. 5A at the same time, the value of the watermark when initially embedded is R₀, as shown in step 500. After the attacking process in step 515, the extracted watermark value is R₂ at step 520. As the strength of the watermark keeps incrementing, in step 510, the value of the watermark embedded in the original digital content moves towards R₁. Assume that the values of the watermarks embedded in the digital content at strength d are smaller or equal to R₃, all the watermarks extracted after attacking process in step 515 will be smaller than T, therefore those greater than R₃ are desired.

If a certain digital process may influence the detection enough to alter the detection result (E>D, and the direction of movement of the detection value is appropriate), then without this digital process, the extracted watermarking pattern may contain only deceptive information. On the other hand, if the recipient performs the digital process negotiated beforehand on the digital content, the watermarking pattern will reveal the genuine information. Referring to FIG. 5C, a schematic diagram depicting deceptive information used to hide the genuine information is shown. When the digital content is not digitally processed in the specific way, the extracted watermark is deceptive, e.g. a sun image 545, whereas if the digital content is digitally processed in the specific way, the extracted watermark reveals the genuine information, e.g. a sunflower image 550.

According to the above method for hiding information in digital content, another embodiment of the present invention includes a method for extracting secret information from digital content, that is, a method for extracting secret information hidden in the digital content generated according to the abovementioned embodiments. First, a first digital content embedded with a first watermark is obtained, wherein the first digital content with the first watermark is generated by embedding a second watermark into a digital content. Then, a predefined attacking process is performed on the first digital content, which manipulates the first digital content in such a way so as to generate a second digital content embedded with the second watermark. A watermark extracting process is performed on the second digital content embedded with the second watermark to extract a watermark, wherein if the watermark extracting process is performed on the first digital content embedded with the first watermark, the extracted watermark is the first watermark, whereas if the watermark extracting process is performed on the second digital content embedded with the second watermark, the extracted watermark is the second watermark. The watermark is outputted. The second watermark does not match with the first watermark. Matching may be the coefficient of correlation between the two watermarks. The first watermark is deceptive information different from the second watermark. The second watermark contains information other than the first watermark, and the second watermark may or may not include the first watermark.

The above second watermark may be a single piece of secret information or consisted of several secrete information. In other words, the second watermark can be embedded one at a time as a whole or in batches. Accordingly, the above method for extracting secret information may further include performing the method for embedding one or more secret information corresponding to the second watermark. The method for embedding secret information includes the following steps. The secret information is weighted using the weighting factors and embedded into the digital content to generate a plurality of first digital content with embedded watermarks corresponding to different weighting factors. Then, the specified attack is performed on the plurality of first digital content to generate respective second digital content corresponding to various weighting factors. Thereafter, the watermark extracting process is performed on the plurality of second digital content to extract the respective watermarks. Second digital content with embedded secret information and second digital content without embedded secret information are identified based on the extracted watermarks, and the smallest weighting factor is identified from all those corresponding to the second digital content with embedded secret information. Finally, the secret information is weighted using the smallest weighting factor and embedded into the digital content, or the first digital content embedded with the watermark corresponding to the smallest weighting factor becomes the first digital content with the first watermark.

Therefore, when the second watermark is embedded once as a whole, the secret information is the second watermark. On the other hand, if the watermark is embedded as a plurality of secret information in batches into the digital content, the above embedding of the secret information weighted by the smallest weighting factor into the digital content can be performed immediately each time after the smallest weighting factor for that piece of secret information is identified, or performed after all the smallest weighting for each piece of secret information are identified.

The above plurality of different weighting factors are a weight series arranged in order, and the plurality of first digital content corresponding to the weighting factors are generated according to the order of the weight series. The weight series include sequentially adjacent first and second weighting factors, the first digital content corresponding to the second weighting factor is generated after the watermark is extracted from the second digital content corresponding to the first weighting factor. When the order of the series is from small to large, and when the first weighting factor is the corresponding largest weighting factor of all the second digital content without embedded second watermark, the second weighting factor is the corresponding smallest weighting factor of all the second digital content with embedded second watermark. When the order of the series is from large to small, and when the second weighting factor is the corresponding largest weighting factor of all the second digital content without embedded second watermark, the first weighting factor is the corresponding smallest weighting factor of all the second digital content with embedded second watermark. Moreover, the second watermark may comprise a plurality of values, each of which is embedded into a different predefined location in the digital content, such that the watermark extracting process extracts the watermark from the plurality of predefined locations.

Additionally, the method for extracting information from digital content further includes: selecting a set of pseudo-random number series as a predefined pseudo-random number series and generating at least one secret information from the second watermark and the predefined pseudo-random number series, the above embedding of the second watermark into the digital content includes embedding the at least one secret information into the digital content.

The above identifying second digital content with embedded secret information and second digital content without embedded secret information based on the extracted watermarks includes: matching each of the secret information extracted from the second digital content corresponding to a different weighting factor with the plurality sets of pseudo-random number series to find respective the most matching pseudo-random number series corresponding to the different weighting factors, identifying the weighting factor having the most matching pseudo-random number series being the predefined pseudo-random number series as the matching weighting factor; otherwise as the mismatching weighting factor, and, based on the matching weighting factors and the mismatching weighting factors, identifying the second digital content with the embedded secret information and the second digital content without secret information from all the second digital content corresponding to different weighting factors. The secret digital content comprises a plurality of binary bits. Each binary bit is designated as one of 1 or −1 according to its binary value and multiplied with the predefined pseudo-random number series to generate respective secret information.

Moreover, the second watermark may comprise a plurality of values, each of which is embedded into a different predefined location in the digital content, such that the watermark extracting process extracts the watermark from the plurality of predefined locations. The plurality of different predefined locations may only contain partial secret information, not the complete second watermark; the watermark consists of the secret information. For example, when only one of the plurality of predefined locations contain secret information, the watermark extracting program ignores locations other than that containing the secret information, and the extracted watermark is the secret information.

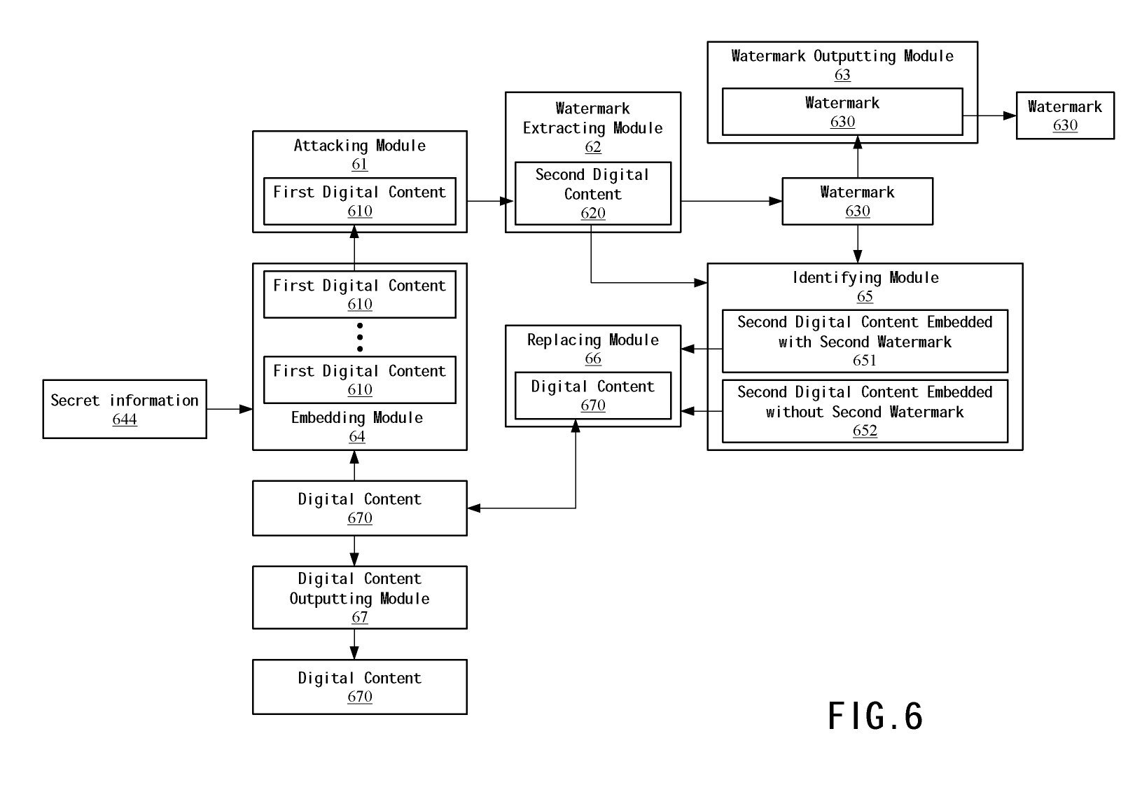

Accordingly, yet another embodiment of the present invention includes a system for hiding and extracting secret information to/from digital content. As shown in FIG. 6, the system includes an attacking module 61, a watermark extracting module 62, a watermark outputting module 63, an embedding module 64, an identifying module 65, a replacing module 66 and a digital content outputting module 67.

The attacking module 61 is used to perform a specified attacking process on the first digital content 610. The specified attack manipulates the first digital content 610 in such a way as to generate a second digital content 620. The generated second digital content 620 is received by the watermark extracting module 62, which performs a watermark extracting process to extract a watermark 630 from the second digital content 620. The watermark 630 is then outputted by the watermark outputting module 63. The first digital content can be stored in a storage medium.

Additionally, if the watermark extracting process is performed on the first digital content 610 with a first watermark, the watermark extracted by the extracting module 62 is the first watermark. On the other hand, if the watermark extracting process is performed on the second digital content 610 with a second watermark 644, the watermark 630 extracted by the extracting module 62 is the second watermark 644. Thus, when the second watermark 644 is embedded into a digital content 670 to become the first digital content 610 with the first watermark, the second watermark 644 can be outputted by the above attacking module 61, the watermark extracting module 62 and the watermark outputting module 63.

Furthermore, the embedding module 64 weights the second watermark 644 using a plurality of weighting factors and embeds them into the digital content 670 to generate a plurality of first digital content 610 with embedded watermarks corresponding to different weighting factors. Thus, after the attacking module 61 and the watermark extracting module 62 extract the watermarks 630 from the first digital content 610 corresponding to different weighting factors, the watermarks 630 can be used by the identifying module 65 to identify each of the second digital content 620 corresponding to different weighting factors as one of second digital content 651 with the embedded second watermark and second digital content 652 without second watermark. Finally, the replacing module 66 identifies the smallest weighting factor among all the weighting factors that correspond to the second digital content 651 with the embedded watermarks, and embeds the second watermark weighted using the smallest weighting factor into the digital content 670. According to the second digital content 620 corresponding to the smallest weighting factors in all the second digital content with the embedded second watermarks, the replacing module 66 selects a first digital content 610 corresponding to the smallest weighting factor as the digital content 670 (first digital content 610 with the embedded first watermark), then the digital content outputting module 67 may output the digital content 670.

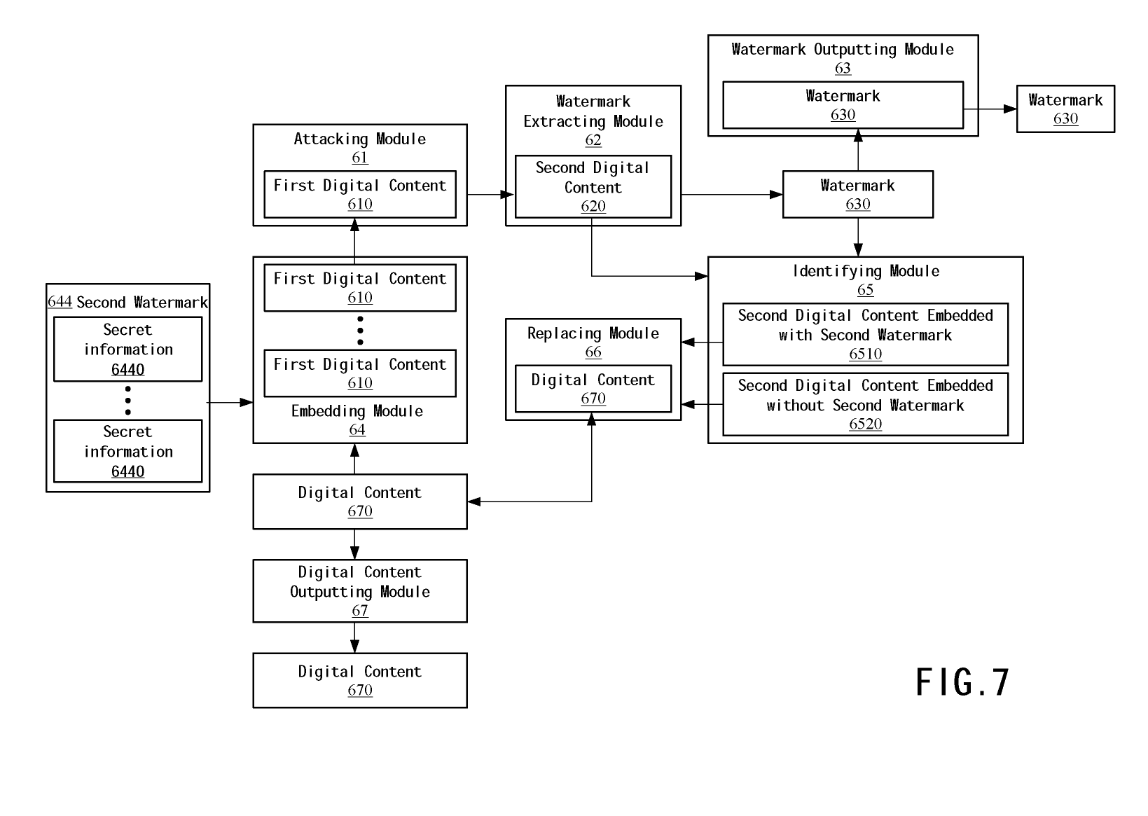

As noted above, the second watermark 644 may be embedded as a whole into the digital content 670, or in several pieces of secret information. As shown in FIG. 7, in one preferred embodiment of the present invention, the second watermark 644 is consisted of at least one piece of secret information. If the second watermark 644 is consisted of only one piece of secret information 6440 (e.g. a text string, a piece of image or a video), the second watermark 644 can be embedded into the digital content once. On the other hand, if the second watermark 644 is consisted of several pieces of secret information 6440 (e.g. each secret information 6440 includes one or more bits), the second watermark 644 can be embedded into the digital content 670 in batches. The time at which information is embedded into the digital content 670 may be after the smallest weighting factor for each secret information is identified, or after weighting factors for all the secret information are identified.

Therefore, the embedding module 64 weights each piece of secret information using a plurality of different weighting factors and embeds them into the digital content to generate a plurality of first digital content 610 with embedded watermarks corresponding to different weighting factors. Then, the specified attack is performed on the plurality of first digital content 610 with embedded watermarks corresponding to different weighting factors to generate respective second digital content 620 corresponding to various weighting factors. Accordingly, the identifying module 65 receives the second digital content 620 corresponding to different weighting factors and the corresponding watermarks 630 from the watermark extracting module 62, and identifies second digital content 6510 with the embedded secret information 6440 and second digital content 6520 without embedded secret information 6440 based on the watermarks 630 of the second digital content 620 corresponding to different weighting factors. Then, the replacing module 66 identifies the smallest weighting factor corresponding to the secret information 6440 from all the second digital content 6510 with embedded secret information 6440, weights the secret information 6440 using the smallest weighting factor and embeds it into the digital content 670.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

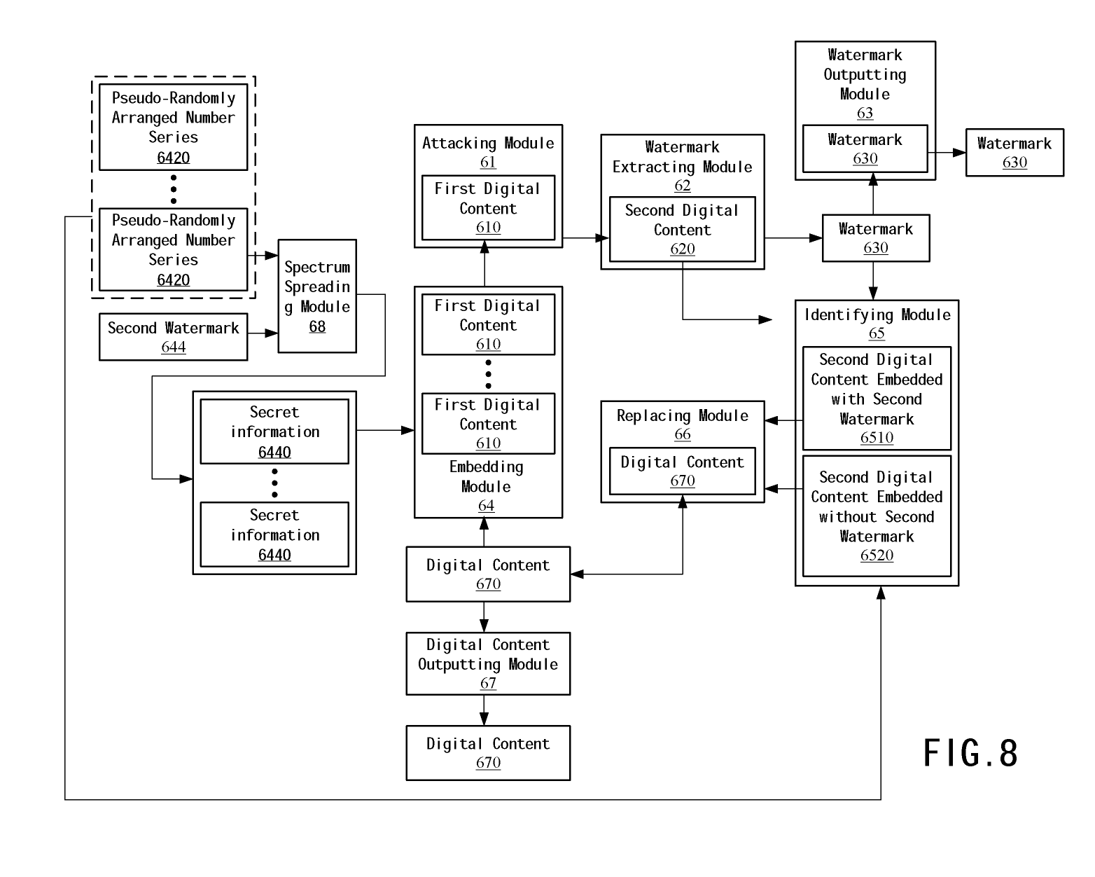

Moreover, this embodiment may further include a spectrum spreading module 68, as shown in FIG. 8. The spectrum spreading module 68 generates a plurality of secret information 6440 corresponding to the second watermark 644 based on the second watermark 644 and a predefined pseudo-randomly arranged number series 6420, wherein the predefined pseudo-randomly arranged number series 6420 is one of a plurality of pseudo-randomly arranged number series that can be stored in a storage medium.

Accordingly, the identifying module 65 executes the following steps. Each of the watermark 630 extracted from the second digital content 620 corresponding to a different weighting factor is matched with the plurality sets of pseudo-random number series 6420 to find respective the most matching pseudo-random number series 6420 corresponding to the different weighting factors. The weighting factor having the most matching pseudo-random number series 6420 being the predefined pseudo-random number series 6420 is identified as the matching weighting factor; else as the mismatching weighting factor. Then, based on the matching weighting factors and the mismatching weighting factors, the second digital content 6510 with the embedded secret information and the second digital content 6520 without secret information are identified.

The above attacking module 61 and the watermark extracting module 62 and the watermark outputting module 63 can be separated from the rest of the modules to form a system for extracting secret information from the digital content. Additionally, the various modules can be implemented by hardware circuit and/or software program, the present invention does not place limit on this. Moreover, other relevant details of the embodiments are already described above, and will not be further discussed.

The above digital content may include graphs, images, audio, texts or any magnetic records in digital format. The digital content can be stored in registers, memories, magnetic disks, optical disks or storage media that can store electromagnetic records. The present invention does not limit the constitution of the digital content and the storage media for storing the digital content.

It is understood, from the descriptions of the embodiments above, that several modifications, changes, and substitutions are possible for the present invention. Rather, the present invention should be interpreted in terms of the scope of the claims. Apart from the above detailed descriptions, the present invention can be broadly implemented in other embodiments. The above are only preferred embodiments of the present invention, and are not intended to limit the claims of the present invention. All modifications and equivalents that are not departed from the spirit disclosed by the present invention should be within the scope of the claims.

1. A method for hiding information in a digital content, including:
receiving a digital content and at least one secret information;
providing a weight series including a plurality of different weighting factors;
performing a method for embedding each secret information including:
generating secret information corresponding to the various weighting factors according to the secret information and the weighting factors;
embedding each secret information with different weighting factor into the digital content to generate respective digital content embedded with secret information corresponding to the various weighting factors;
performing a predefined attack on each of the digital content embedded with secret information corresponding to the various weight factors to generate respective tampered digital content corresponding to various weighting factors;
extracting tampered secret information corresponding to various weighting factors from the tampered digital content corresponding to various weighting factors, respectively;
matching each of the tampered secret information corresponding to various weighting factors with the secret information so as to identify each of said weighting factors is a matching weighting factor or a mismatching weighting factor;
identifying a smallest matching weighting factor from all the matching weighting factors; and
embedding the secret information corresponding to the smallest matching weighting factor into the digital content; and
outputting the digital content.

2. A method for hiding information in a digital content of claim 1, wherein the weight series is arranged in an order, wherein the secret information corresponding to various weighting factors are generated according to the order.

3. A method for hiding information in a digital content of claim 2, wherein the weight series includes a first weighting factor and a second weight factor that are sequentially adjacent, the secret information corresponding to the second weighting factor is generated after the tampered secret information corresponding to the fist weighting factor is matched with the secret information.

4. A method for hiding information in a digital content of claim 3, wherein the order of the series is from small to large, wherein when the first weighting factor is the largest mismatching weighting factor, the second weighting factor is the smallest matching weighting factor.

5. A method for hiding information in a digital content of claim 3, wherein the order of the series is from large to small, wherein when the second weighting factor is the largest mismatching weighting factor, the first weighting factor is the smallest matching weighting factor.

6. A method for hiding information in a digital content of claim 3, wherein the embedding of the secret information corresponding to the smallest matching weighting factor into the digital content includes replacing the digital content with the digital content embedded with the secret information that corresponds to the smallest matching weighting factor.

7. A method for hiding information in a digital content of claim 1, wherein the embedding of the secret information corresponding to the smallest matching weighting factor into the digital content is carried out after the smallest matching weighting factors corresponding to all the secret information are identified.

8. A method for hiding information in a digital content of claim 1, wherein the matching of each of the tampered secret information corresponding to various weighting factors with the secret information includes generating a likelihood value that correspond to each weighting factor, when the likelihood value is greater than a threshold value, the weighting factor corresponding to that likelihood value is identified as a matching weighting factor, else as a mismatching weighting factor.

9. A method for hiding information in a digital content of claim 1, further including:
providing a secret digital content;
providing a plurality sets of number series that are pseudo-randomly arranged;
selecting one of the plurality sets of pseudo-random number series as a predefined pseudo-random number series; and
generating at least one secret information from the secret digital content and the predefined pseudo-random number series.

10. A method for hiding information in a digital content of claim 9, wherein the matching of each of the tampered secret information corresponding to the various weighting factors with the secret information includes:
matching each of the tampered secret information corresponding to the various weighting factors with the plurality sets of pseudo-random number series to find the most matching pseudo-random number series corresponding to the various weighting factors, respectively; and
identifying the weighting factors having the most matching pseudo-random number series being the predefined pseudo-random number series as the matching weighting factor, else as the mismatching weighting factor.

11. A method for hiding information in a digital content of claim 9, wherein the matching of each of the tampered secret information corresponding to the various weighting factors with the secret information further includes:
matching each of the tampered secret information corresponding to various weighting factors with the plurality sets of pseudo-random number series to find the most matching pseudo-random number series corresponding to the various weighting factors, respectively;
reconstructing a respective reconstructed information based on each of the most matching pseudo-random number series corresponding to various different weighting factors and the tampered secret information; and
identifying the weighting factors having the corresponding reconstructed information matching the secret information as the matching weighting factor, else as the mismatching weighting factor.

12. A method for hiding information in a digital content of claim 9, wherein the secret digital content includes a plurality of binary bits, each binary bit is designated as one of 1 or −1 according to its binary value and multiplied with the predefined pseudo-random number series to generate a respective secret information.

13. A method for hiding information in a digital content of claim 1, wherein the method for embedding each secret information includes carrying out the method for one secret information after another.

14. A method for hiding information in a digital content of claim 1, wherein the secret information includes a plurality of values, each value is embedded into a different predefined location in the digital content, such that each tampered secret information corresponding to the weighting factor is extracted from the plurality of predefined locations in the tampered digital content corresponding to the specific weighting factor.

15. A method for extracting information from a digital content, including:
obtaining a first digital content embedded with a first watermark, wherein the first digital content with the first watermark is generated by embedding a second watermark into a digital content;
performing a predefined attacking process on the first digital content, the predefined attacking process manipulating the first digital content in such a way so as to generate a second digital content embedded with the second watermark;
performing a watermark extracting process on the second digital content embedded with the second watermark to extract a watermark, wherein if the watermark extracting process is performed on the first digital content embedded with the first watermark, the extracted watermark is the first watermark, whereas if the watermark extracting process is performed on the second digital content embedded with the second watermark, the extracted watermark is the second watermark; and
outputting the watermark, wherein the second watermark does not match with the first watermark.

16. A method for extracting information from a digital content of claim 15, wherein the first watermark is deceptive information that is different from the second watermark.

17. A method for extracting information from a digital content of claim 15, wherein the second watermark contains information other than the first watermark.

18. A method for extracting information from a digital content of claim 15, wherein the second watermark includes the first watermark.

19. A method for extracting information from a digital content of claim 15, further comprising performing a method for embedding at least one secret information corresponding to the second watermark, including:
weighting the secret information using a plurality of different weighting factors and embedding them into the digital content to generate a plurality of first digital content embedded with watermarks corresponding to the different weighting factors;
performing the predefined attacking process on the plurality of first digital content to generate respective second digital content corresponding to the various weighting factors;
performing the watermark extracting process on the plurality of second digital content to extract the respective watermarks;
identifying the second digital content with the embedded secret information and the second digital content without the embedded secret information based on the extracted watermarks;
identifying a smallest weighting factor from all the weighting factors that correspond to the second digital content with the embedded secret information; and
weighting the secret information using the smallest weighting factor and embedding it into the digital content.

20. A method for extracting information from a digital content of claim 19, wherein the weighting factors are a weight series arranged in an order, wherein the plurality of first digital content corresponding to the various weighting factors are generated according to the order.

21. A method for extracting information from a digital content of claim 20, wherein the weight series includes a first weighting factor and a second weight factor that are sequentially adjacent, the first digital content embedded with the watermark corresponding to the second weighting factor is generated after the watermark is extracted from the second digital content corresponding to the fist weighting factor.

22. A method for extracting information from a digital content of claim 21, wherein the order of the series is from small to large, wherein when the first weighting factor is the corresponding largest weighting factor among all the second digital content without the embedded second watermark, the second weighting factor is the corresponding smallest weighting factor among all the second digital content with the embedded second watermark.

23. A method for extracting information from a digital content of claim 21, wherein the order of the series is from large to small, wherein when the second weighting factor is the corresponding largest weighting factor among all the second digital content without the embedded second watermark, the first weighting factor is the corresponding smallest weighting factor of all the second digital content with the embedded second watermark.

24. A method for extracting information from a digital content of claim 21, wherein the weighting and embedding of the second watermark using the smallest weighting factor into the digital content includes using the first digital content embedded with the watermark corresponding to the smallest weighting factor as the first digital content embedded with the first watermark.

25. A method for extracting information from a digital content of claim 19, wherein the secret information is the second watermark.

26. A method for extracting information from a digital content of claim 19, wherein there is a plurality of secret information, and the second watermark is consisted of a plurality of the secret information.

27. A method for extracting information from a digital content of claim 26, wherein the weighting and embedding of the second watermark using the smallest weighting factor into the digital content is carried out after the smallest weighting factors for all the secret information are identified.

28. A method for extracting information from a digital content of claim 19, further including:
providing a plurality sets of number series that are pseudo-randomly arranged;
selecting one of the plurality sets of pseudo-random number series as a predefined pseudo-random number series; and
generating at least one secret information according to the second watermark and the predefined pseudo-random number series.

29. A method for extracting information from a digital content of claim 28, wherein the identifying of the second digital content with the embedded secret information and the second digital content without the embedded secret information based on the extracted watermarks includes:
matching each of the watermarks extracted from the second digital content corresponding to the various weighting factors with the plurality sets of pseudo-random number series to find the most matching pseudo-random number series corresponding to the various weighting factors, respectively;
identifying the weighting factors having the most matching pseudo-random number series being the predefined pseudo-random number series as the matching weighting factor, else as the mismatching weighting factor; and
identifying the second digital content with the embedded secret information and the second digital content without the embedded secret information from all the second digital content corresponding to various weighting factors according to the matching weighting factors and the mismatching weighting factors.

30. A method for extracting information from a digital content of claim 28, wherein the secret information includes a plurality of binary bits, each binary bit is designated as one of 1 or −1 according to its binary value and multiplied with the predefined pseudo-random number series to generate a respective secret information.

31. A method for extracting information from a digital content of claim 15, wherein the second watermark includes a plurality of values, each value is embedded into a different predefined location in the digital content, such that the watermark extracting process extracts the watermark from the plurality of predefined locations.

32. A system for hiding and extracting secret information into/from a digital content, including:
a storage medium stored with a first digital content embedded with a first watermark, wherein the first digital content embedded with the first watermark is generated by embedding a second watermark into a digital content;
an attacking module for performing a predefined attacking process on the first digital content, the predefined attacking process manipulating the first digital content in such a way so as to generate a second digital content embedded with the second watermark;
a watermark extracting module for performing a watermark extracting process on the second digital content embedded with the second watermark to extract a watermark, wherein if the watermark extracting process is performed on the first digital content embedded with the first watermark, the extracted watermark is the first watermark, whereas if the watermark extracting process is performed on the second digital content embedded with the second watermark, the extracted watermark is the second watermark; and
a watermark outputting module for outputting the watermark, wherein the second watermark does not match with the first watermark.

33. A system for hiding and extracting secret information into/from a digital content of claim 32, wherein the first watermark is deceptive information that is different from the second watermark.

34. A system for hiding and extracting information into/from a digital content of claim 32, wherein the second watermark contains information other than the first watermark.

35. A system for hiding and extracting secret information into/from a digital content of claim 34, wherein the second watermark includes the first watermark.

36. A system for hiding and extracting secret information into/from a digital content of claim 32, further comprising:
an embedding module for weighting the secret information using a plurality of different weighting factors and embedding them into the digital content to generate a plurality of first digital content embedded with watermarks corresponding to the different weighting factors, wherein the second watermark is consisted of at least one secret information, and the predefined attacking process manipulates each of the plurality of first digital content embedded with watermarks corresponding to the different weighting factors in such a way so as to generate respective second digital content corresponding to the various weighting factors;
a digital content for generating the second digital content corresponding to various weighting factors;
an identifying module for receiving the second digital content corresponding to various weighting factors and their corresponding watermarks from the watermark extracting module, and identifying the second digital content with the embedded secret information and the second digital content without the embedded secret information based on each of the watermarks of the second digital content corresponding to various weighting factors; and
a replacing module for identifying a smallest weighting factor from all the weighting factors that correspond to the second digital content with the embedded secret information and weighting the secret information using the smallest weighting factor and embedding it into the digital content.

37. A system for hiding and extracting secret information into/from a digital content of claim 36, wherein after identifying the smallest weighting factors for all the secret information, the replacing module weights each secret information using the identified smallest weighting factor and embedding it into the digital content.

38. A system for hiding and extracting secret information into/from a digital content of claim 36, wherein the weighting factors are a weight series arranged in an order, wherein the plurality of first digital content corresponding to the various weighting factors are generated according to the order.

39. A system for hiding and extracting secret information into/from a digital content of claim 38, wherein the weight series includes a first weighting factor and a second weight factor that are sequentially adjacent, the first digital content embedded with the watermark corresponding to the second weighting factor is generated after the watermark is extracted from the second digital content corresponding to the fist weighting factor.

40. A system for hiding and extracting secret information into/from a digital content of claim 39, wherein the order of the series is from small to large, wherein when the first weighting factor is the corresponding largest weighting factor among all the second digital content without the embedded second watermark, the second weighting factor is the corresponding smallest weighting factor among all the second digital content with the embedded second watermark.

41. A system for hiding and extracting secret information into/from a digital content of claim 38, wherein the order of the series is from large to small, wherein when the second weighting factor is the corresponding largest weighting factor among all the second digital content without the embedded second watermark, the first weighting factor is the corresponding smallest weighting factor of all the second digital content with the embedded second watermark.

42. A system for hiding and extracting secret information into/from a digital content of claim 32, further including a spectrum spreading module for generating the at least one secret information according to the second watermark and a set of pseudo-randomly arranged number series selected from one of a plurality sets of pseudo-randomly arranged number series.

43. A system for hiding and extracting secret information into/from a digital content of claim 42, wherein the identifying module for identifying the second digital content with the embedded secret information and the second digital content without the embedded secret information based on the extracted watermarks further includes:
matching each of the watermarks extracted from the second digital content corresponding to the various weighting factors with the plurality sets of pseudo-random number series to find the most matching pseudo-random number series corresponding to the various weighting factors, respectively;
identifying the weighting factors having the most matching pseudo-random number series being the predefined pseudo-random number series as the matching weighting factor, else as the mismatching weighting factor; and
identifying the second digital content with the embedded secret information and the second digital content without the embedded secret information from all the second digital content corresponding to various weighting factors according to the matching weighting factors and the mismatching weighting factors.

44. A system for hiding and extracting secret information into/from a digital content of claim 42, wherein the secret information includes a plurality of binary bits, each binary bit is designated as one of 1 or −1 according to its binary value and multiplied with the predefined pseudo-random number series to generate a respective secret information.

45. A system for hiding and extracting secret information into/from a digital content of claim 32, wherein the second watermark includes a plurality of values, each value is embedded into a different predefined location in the digital content, such that the watermark extracting process extracts the watermark from the plurality of predefined locations.
